(19) United States
(12) Patent Application Publication
(10) Pub. No.: US 2024/0263639 A1
(43) Pub. Date: Aug. 8, 2024

(54) IMPELLER AND METHOD OF MANUFACTURING AN IMPELLER

(71) Applicant: EBARA PUMPS EUROPE S.P.A, CLES (TRENTO) (IT)

(72) Inventors: Paolo BALZARIN, VIGASIO (VERONA) (IT); Stefano AVANZI, VERONA (VERONA) (IT); Fabrizio BENETTON, (MOLLARO)PREDAIA(TRENTO) (IT); Marco TROVI, TIRRENIA (PISA) (IT)

(73) Assignee: EBARA PUMPS EUROPE S.P.A., CLES (TRENTO) (IT)

(21) Appl. No.: 18/567,298

(22) PCT Filed: May 31, 2022
(86) PCT No.: PCT/EP2022/064693

§ 371 Date: Dec. 5, 2023

(30) Foreign Application Priority Data
Jun. 10, 2021 (IT) 102021000015179

(51) Int. Cl. F04D 29/22; B21D 53/26; F04D 17/08

(52) U.S. Cl. CPC F04D 29/22; B21D 53/267; F04D 17/08

(57) ABSTRACT

An impeller, particularly for centrifugal pumps, including a front plate and a back plate arranged coaxially to a central axis of the impeller and rigidly connected to each other by a plurality of radial blades which are angularly distributed about the central axis; the front plate has a central through opening adapted to connect the impeller to a driving shaft; the impeller includes a reinforcement portion that extends perimetrically to the through opening, at least partially surmounting the front plate; the front plate and the reinforcement portion are constituted by a single part formed by stamping, bending and flattening a metal sheet.

The present invention relates to an impeller and to a method of manufacturing an impeller, particularly for centrifugal pumps.

As is known, centrifugal pumps are fluid dynamics machines in which mechanical energy acts on the fluid in input to the pump, by means of the centrifugal acceleration that is imparted thereto by means of the rotation of one or more impellers.

In practice, the task of each impeller is to draw the fluid from an intake duct and transfer, to the fluid, the mechanical energy transmitted by the motor in the form of kinetic energy.

Centrifugal pumps may have a single impeller, in a single-stage configuration, or a plurality of impellers arranged in series, in which case they are referred to as multistage pumps.

The impeller is essentially a rotating element provided with blades that have a generally radial extension and form diverging ducts; the impellers may be manufactured with several constructive variations according to the requirements and the required performance.

In particular, impellers made of stamped sheet metal are generally made of pairs of disk shaped plates that face each other axially so as to form an interspace wherein radial blades rigidly connect the two plates.

Also, a hub, or an equivalent coupling device, is provided centrally to each impeller and allows to fix the impeller to a driving shaft which is functionally connected to a motor means.

Regards the torque transmission, the impellers made of stamped sheet metal according to the prior art are substantially of two types.

According to a first type, the basic disk of the impeller, i.e., the plate that is designed to transmit the torque between the blades and the driving shaft, is formed with a thickness that is adequate to withstand the stresses.

According to a second type of construction, reinforcement elements are welded in the area assigned to stress transmission, so as to reach the necessary thickness of material only in a localized portion.

The second type of construction is generally adopted if the stresses are such that it would be uneconomical to solve the problem of torque transmission just by means of the augmented thickness.

The above described techniques solve some of the problems cited above, however they involve high production costs and a production process which sometimes also involves external suppliers, with obvious problems and risks linked to supply.

Also, the above described techniques generally entail an increase in the overall weight of the impeller.

DE4446193A1 discloses a method of manufacturing centrifugal pumps involving cutting both the blades and the cover bodies from metal sheet and assembling in position. The blades are then welded to the cover bodies using a laser beam which is applied to the side of the cover bodies opposite to the contact point with the blades. The second cover body is welded to the blades in a similar operation to that used when welding the blades to the first cover body.

US2017/260992A1 discloses an impeller assembly that has two disk members having different diameters, arranged coaxially to a rotation axis and facing each other so as to form an interspace; blades are radially arranged in the interspace; the two disk members are also centrally provided with a fastening means for fastening to a transmission shaft, which rotates about the rotation axis. Contoured vanes protrude radially from the peripheral region of the disk member that has the smallest diameter and are arranged at the blades.

JPS5884618A discloses manufacturing a light annular flange plate fitted with a boss part, by press working an annular thin plate provided with a cylindrical projection obtained by working a material and buckling the cylindrical projection.

US2012/315109A1 discloses a metal member defining a hole in which the hole is reinforced by forming a flange and turning the flange back upon itself so that the rolled outer surface of the flange defines the perimeter of the hole. The sheared edge is spaced from the perimeter of the hole. The shaft of the fastener inserted in the hole contacts a non-sheared surface. A reinforcement ring may be assembled around the flange.

The aim of the present invention is to provide an impeller and a method for manufacturing an impeller, particularly for centrifugal pumps, that overcome the drawbacks of the cited prior art.

Within the scope of this aim, a particular object of the invention is to provide an impeller and a method that allow to obtain a good compromise between the need to reduce production costs and the weight of the impeller and the need to ensure the necessary mechanical characteristics to the impeller.

A further object of the invention is to provide an impeller and a method that allow to minimize processing times, maximizing the total production capacity of the system.

A further object of the invention is to provide an impeller and a method that are safe, efficient and relatively simple to actuate.

This aim and these objects, as well as others which will become better apparent hereinafter, are achieved by an impeller, particularly for centrifugal pumps, comprising a front plate and a back plate arranged coaxially to a central axis of said impeller and rigidly connected to each other by means of a plurality of radial blades that are angularly distributed about said central axis; said front plate having a central through opening adapted to connect said impeller to a driving shaft; said impeller being characterized in that it comprises a reinforcement portion that extends perimetrically to said through opening, at least partially surmounting said front plate; said front plate and said reinforcement portion being constituted by a single piece of stamped, bent and flattened metal sheet.

The aim and objects of the invention are also achieved by a method for manufacturing an impeller, particularly for centrifugal pumps, said impeller comprising a front plate and a back plate arranged coaxially to each other and rigidly connected to each other by a plurality of radial blades that are angularly distributed about a central axis of said impeller; said front plate having a central through opening preset for the connection of said impeller to a driving shaft, said method comprising the steps of:
a) forming said front plate and the associated through opening by stamping a sheet of metal;
b) forming said back plate by stamping a sheet of metal;
c) forming said radial blades by stamping a sheet of metal;
d) rigidly connecting said radial blades to one between said front plate and said back plate so that said radial blades are angularly distributed about said central axis of said impeller;
e) rigidly connecting said radial blades to the other one between said front plate and said back plate;
said method being characterized in that said step a) comprises the steps of:
a1) folding over at least one portion of the excess material from at least one portion of the edge region of said through opening;
a2) flattening the portion of excess material folded over during step a1) on said front plate, so as to form a reinforcement portion that extends perimetrically to said through opening, surmounting said front plate at least partially.

Further characteristics and advantages will become better apparent from the description of preferred but not exclusive embodiments of an impeller according to the invention, illustrated by way of non-limiting example in the accompanying drawings, wherein:

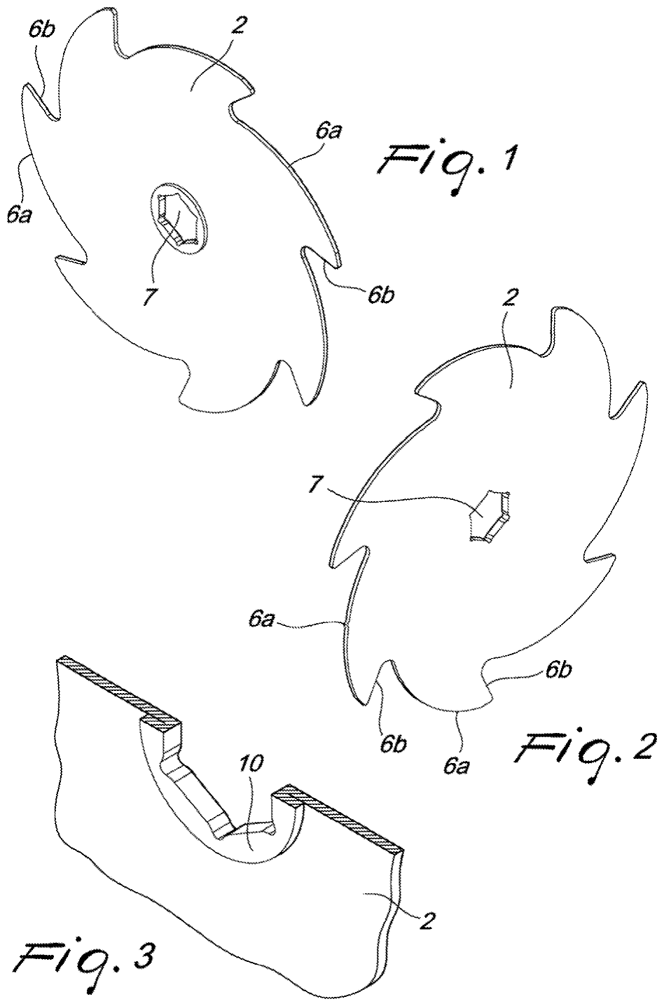

FIG. 1 is a perspective view of a component of an impeller according to the invention;

FIG. 2 is another perspective view of the component of the preceding figure;

FIG. 3 is an enlarged sectional view of a detail of the component of FIGS. 1 and 2;

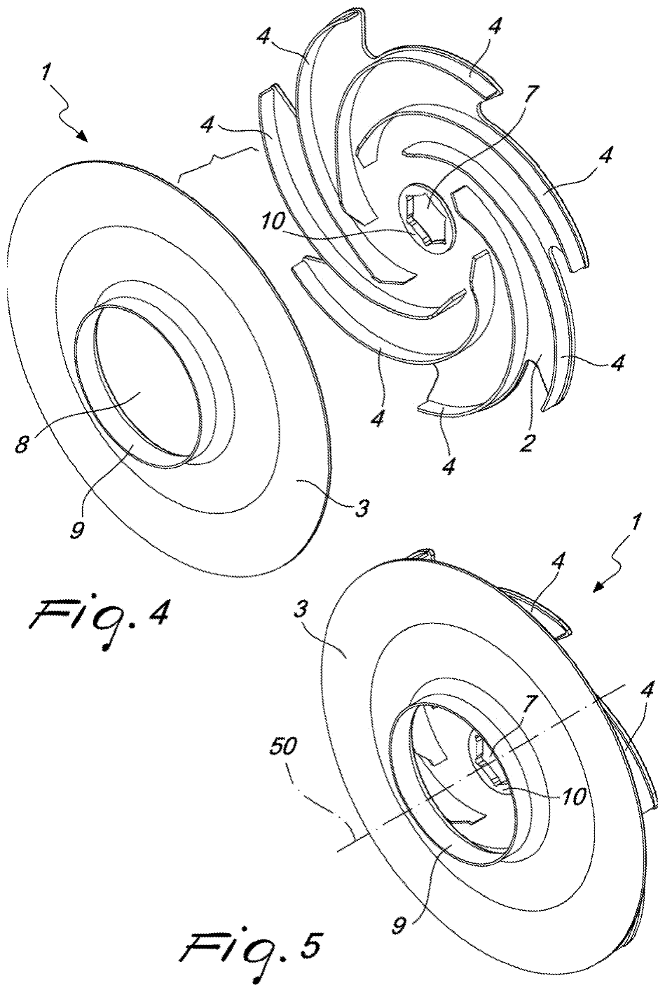

FIG. 4 is an exploded view of an impeller according to the invention;

FIG. 5 is a perspective view of the impeller of the preceding figure;

FIG. 6 is another perspective view of the impeller of FIGS. 4 and 5;

FIG. 7 is a front view of an impeller according to the invention;

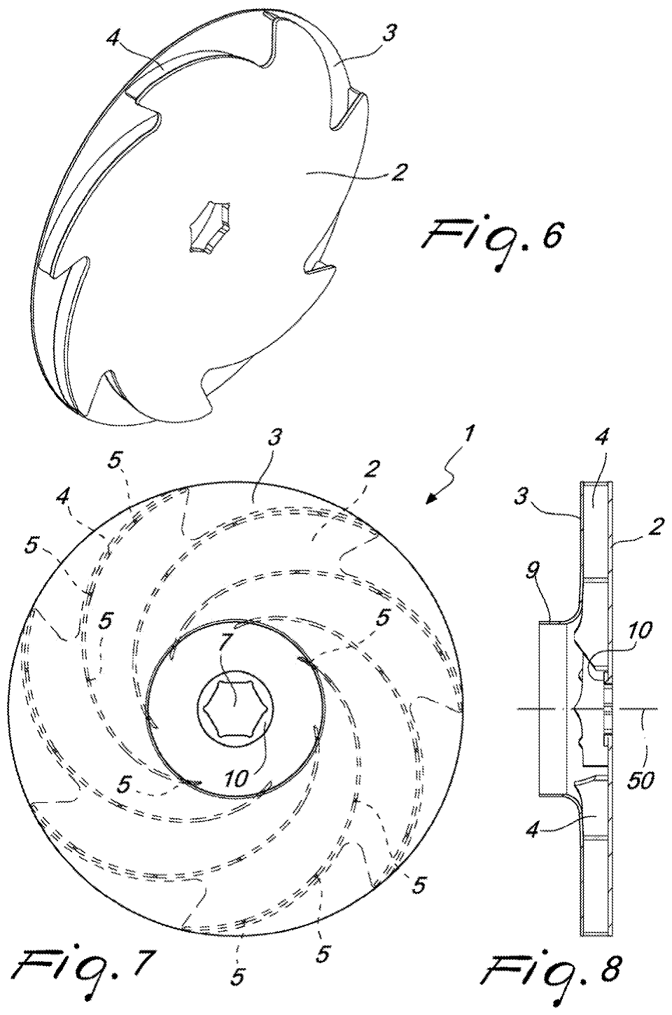

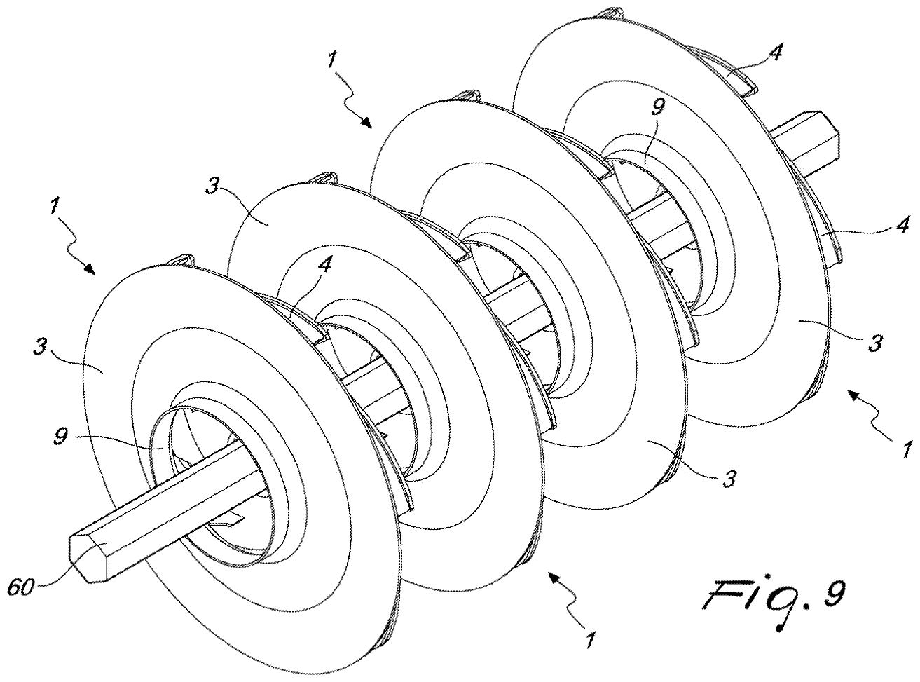

FIG. 8 is a diametrical sectional view of the impeller of FIG. 7;

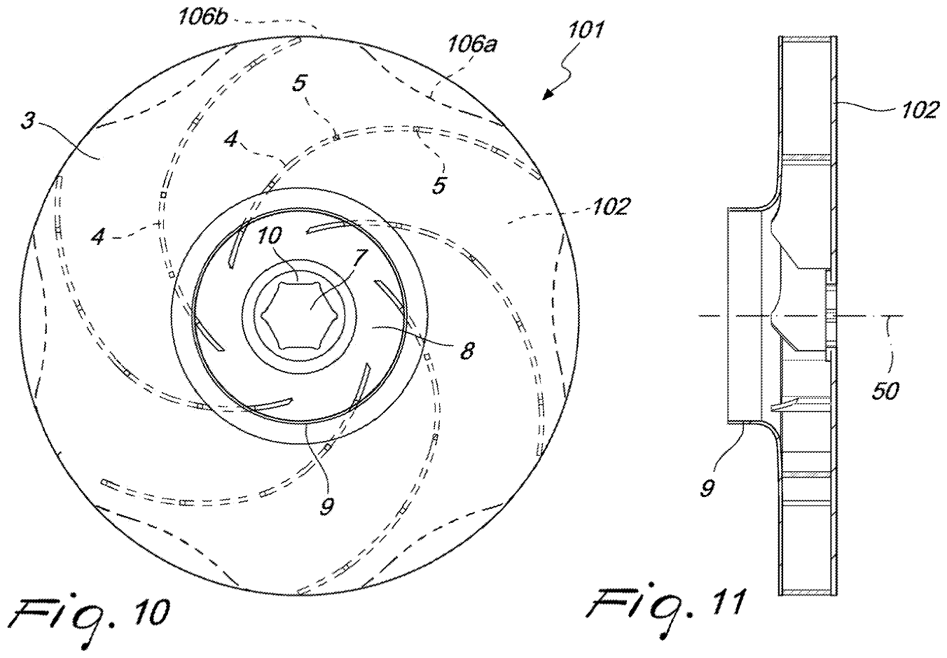

FIG. 9 is a perspective view of a plurality of impellers mounted on a driving shaft of a multistage pump;

FIG. 10 is a front view of another embodiment of an impeller according to the invention;

FIG. 11 is a diametrical sectional view of the impeller of FIG. 10.

With reference to the cited figures, the reference numerals 1 and 101 generally designate an impeller, particularly adapted for use in centrifugal pumps.

For example, the impeller 1, 101 is to be mounted on a multistage centrifugal pump, which is per se known and not shown in the figures, wherein each stage includes an impeller of the type according to the invention, preset to rotate in a respective chamber, as shown by way of example in FIG. 9.

However, it will be evident to the person skilled in the art, that the impeller 1, 101 or a structure that is equivalent thereto can be used advantageously also in fluid dynamics machines of another type.

The impeller 1, 101, which is advantageously made of stainless steel plate, includes a front plate 2, 102 and a back plate 3 which are arranged coaxially along a central axis 50 thereof.

The front plate 2, 102 and the back plate 3 are rigidly connected to each other by means of a plurality of radial blades 4, for example by means of spot welds 5.

It is evident to the person skilled in the art that, in alternative embodiments, not shown, the radial blades 4 might also be provided monolithically with either the front plate 2, 102 or the back plate 3.

The radial blades 4 are angularly distributed about the central axis 50 and preferably extend along a spiral or generally curvilinear path.

The front plate 2, 102 is substantially disk-shaped and advantageously has a perimetric profile that is shaped so as to reduce the axial thrusts that are generated during pumping.

In the embodiment shown in FIGS. 1 to 9, for example, the front plate 2 substantially has a saw tooth profile which is formed by an alternation of first curvilinear portions 6a, that are substantially parallel to the radial blades 4, and second curvilinear portions 6b, which are transverse to the blades 4, which blend together.

In the example shown in FIGS. 10 and 11, wherein the impeller according to the invention is designated by the reference numeral 101 and the components that have the same structure and function as those of FIGS. 1 to 9 are designated by the same reference numerals, the front plate 102 substantially has a lobate profile which is formed by an alternation of recesses 106a, provided between the radial blades 4, and circular portions 106b, which blend together.

It is evident to the person skilled in the art that, in alternative embodiments, not shown, the impeller according to the present invention may include a front plate with a profile that is different from the ones exemplified here.

The front plate 2, 102 has a front through opening 7 designed for the connection of the impeller 1, 101 to a driving shaft 60, which, during use, is functionally connected to a motor means, not shown, that turn the driving shaft.

Advantageously, the profile of the through opening 7 is substantially complementary to the profile of the transverse cross-section of the driving shaft 60.

The back plate 3 has a central through hole 8 with has a diameter that is larger than the through opening 7 and of the driving shaft 60.

The through hole 8 forms an intake channel of the impeller 1, together with a collar 9 which extends from the through hole 8.

According to the present invention, the impeller 1, 101 includes a reinforcement portion which extends perimetrically to the through opening 7, at least partially surmounting the front plate 2, 102.

Also according to the invention, the front plate 2, 102 and the reinforcement portion 10 are constituted by a single part formed by stamping, folding (or folding over) and flattening a metal sheet, as will become better apparent hereinafter.

Namely, the reinforcement portion 10 is substantially annular and is centrally provided with the through opening 7.

The reinforcement portion 10 completely adheres to the front plate 2, 102.

Advantageously, as an effect of the folding and subsequent flattening, a work hardening of the material occurs at the folding line between the reinforcement portion 10 and the front plate 2, 102, with a consequent increase of its mechanical strength.

Experimental tests conducted by this Applicant have shown that, as an effect of the work-hardening, the hardness of the material increases by 2 or 3 times with respect to the hardness of the source material.

A further important advantageous aspect of the impeller 1, 101 is that the surface of the internal face of the through opening 7, which is designed to make contact with the driving shaft 60, doubles, because it is defined by the superimposition of the reinforcement portion 10 on the front plate 2, 102.

In this manner, the contact pressure generated by the torque between the driving shaft 60 and the impeller 1, 101 is reduced significantly.

On the basis of the above, the method of manufacturing the impeller according to the invention includes a step a) of forming a single part, by stamping a metal sheet, wherein the single part forms the front plate 2, 102 and its corresponding through opening 7.

As described earlier, the front plate 2, 102 has a substantially disk-like shape, with a perimetric profile that is shaped so as to reduce the axial thrusts generated during pumping.

The through opening 7 has an edge which is substantially complementary to the profile of the transverse cross-section of the driving shaft 60.

According to the invention, the method includes a step a1) of folding, or folding over, at least one portion of excess material from at least one portion of the edge region of the through opening 7.

Preferably, the excess material from the entire edge of the through opening 7 is folded over.

The method further includes a step a2) wherein the previously folded over excess material is flattened onto the front plate 2, 102, so as to form the reinforcement portion 10 that extends perimetrically to the through opening 7, surmounting at least partially the front plate 2, 102.

In practice, the excess material is deformed until it forms the reinforcement portion 10, which appears substantially like an annular element which completely adheres to the front plate 2, 102.

By virtue of an intense compression of the material, no radiuses form on the edges, as shown by way of example in FIG. 3.

The method according to the invention also includes a further step b) of forming a single piece by stamping a metal sheet, such single piece forming the back plate 3 and the collar 9, which forms the through hole 8.

The method according to the invention also includes a further step c) of forming the radial blades 4 by stamping a metal sheet.

The method according to the invention also includes two additional steps d) and e) of rigidly connecting the radial blades 4 to the front plate 2, 102 and to the back plate 3.

The steps a), b), and c), as well as the steps d) and e), do not have to be performed with a precise mutual sequence: it makes no difference to perform one or the other first or all simultaneously.

Steps a), a1) and a2) have to be performed in succession.

Stamping is preferably cold stamping, but also hot stamping may be used with a subsequent treatment for the hardening and tempering of the material.

The method according to the invention allows to obtain a reinforcement that is localized to the region of the front plate 2, 102 in which it is necessary to increase rigidity and mechanical strength, minimizing the cost and overall weight of the impeller 1, 101.

In practice it has been found that the invention achieves the intended aim and objects, providing an impeller, particularly for centrifugal pumps, and a method for its provision that allow to achieve a good compromise between the need to reduce production costs and the weight of the impeller and the need to ensure the necessary mechanical characteristics of the impeller.

In particular, the invention allows to have lower thicknesses of source material for equal mechanical characteristics with respect to traditional ones.

Also, from the point of view of industrial management, the present invention allows to use only one code, avoiding to manage three different codes for each basic disk (front plate, hub and assembly).

A further advantages is that the present invention does not require the process of welding the hub and that the front plate and the reinforcement portion can be formed integrally by using substantially any press, so long as it is provided with adequate pressure and a suitable resting surface.

This application claims the priority of Italian Patent Application No. 102021000015179, filed on Jun. 10, 2022, the subject matter of which is incorporated herein by reference.

We claim:

1. An impeller, particularly for centrifugal pumps, comprising a front plate and a back plate arranged coaxially to a central axis of said impeller and rigidly connected to each other by means of a plurality of radial blades that are angularly distributed about said central axis; said front plate having a central through opening adapted to connect said impeller to a driving shaft; said impeller comprising a reinforcement portion that extends perimetrically to said through opening, at least partially surmounting said front plate; said front plate and said reinforcement portion being constituted by a single piece of stamped, bent and flattened metal sheet.

2. The impeller according to claim 1, wherein said reinforcement portion is substantially annular.

3. The impeller according to claim 1, wherein said reinforcement portion completely adheres to said front plate.

4. The impeller according to claim 1, comprising a portion of work-hardened material that substantially extends at the bending lines between said front plate and said reinforcement portion.

5. The impeller according to claim 1, wherein said bending lines between said front plate and said reinforcement portion form sharp edges.

6. The impeller according to claim 1, wherein said front plate has a shaped perimetric profile, reducing axial thrusts.

7. The impeller according to claim 1, wherein said back plate has a central through hole having a diameter larger than said through opening and said driving shaft.

8. A method of manufacturing an impeller, particularly for centrifugal pumps, said impeller comprising a front plate and a back plate arranged coaxially to each other and rigidly connected to each other by a plurality of radial blades that are angularly distributed about a central axis of said impeller; said front plate having a central through opening preset for the connection of said impeller to a driving shaft, said method comprising the steps of:
a) forming said front plate and the associated through opening by stamping a sheet of metal;
b) forming said back plate by stamping a sheet of metal;
c) forming said radial blades by stamping a sheet of metal;
d) rigidly connecting said radial blades to one between said front plate and said back plate so that said radial blades are angularly distributed about said central axis of said impeller;
e) rigidly connecting said radial blades to the other one between said front plate and said back plate;
wherein said step a) comprises the steps of:
a1) folding over at least one portion of the excess material from at least one portion of the edge region of said through opening;
a2) flattening the portion of excess material folded over during step a1) on said front plate, so as to form a reinforcement portion that extends perimetrically to said through opening, surmounting said front plate at least partially.

9. The method according to claim 8, wherein said reinforcement portion is substantially annular.

10. The method according to claim 8, wherein said reinforcement portion is completely rested against said front plate.
